(19) United States
(12) Patent Application Publication
(10) Pub. No.: US 2026/0250151 A1
(43) Pub. Date: Aug. 27, 2026

(54) METAL COMPOSITE COMPOUND, METHOD FOR PRODUCING METAL COMPOSITE COMPOUND, AND METHOD FOR PRODUCING LITHIUM METAL COMPOSITE OXIDE

(71) Applicant: TANAKA CHEMICAL CORPORATION, Fukui (JP)

(72) Inventors: Tomoya KURODA, Fukui-shi (JP); Keiji DEGURA, Fukui-shi (JP)

(21) Appl. No.: 18/875,859

(22) PCT Filed: Jul. 14, 2023
(86) PCT No.: PCT/JP2023/026131

§ 371 Date: Dec. 17, 2024

(30) Foreign Application Priority Data
Jul. 15, 2022 (JP) 2022-114299

(51) Int. Cl. C01G 53/506

(52) U.S. Cl. CPC C01G 53/506; C01P 2004/03; C01P 2004/45; C01P 2004/51; C01P 2004/61; C01P 2006/40

(57) ABSTRACT

A metal composite compound containing at least Ni, the metal composite compound including: primary particles; and secondary particles which are aggregates of the primary particles, in which the primary particles constituting the secondary particles have a standard deviation of a minor diameter of 0.1 Å or more and 100 Å or less, the secondary particles include secondary particles X having a high density portion in which the primary particles are aggregated at a high density and a low density portion in which the primary particles are aggregated at a low density, and in a case where a binarized image is obtained by binarizing the high density portion and the low density portion in a scanning electron microscope image of a cross section of the secondary particle X, a standard deviation of a ratio of an area of the low density portion of the secondary particle X, which is obtained from the binarized image, is 0.5% or more and 20% or less, and an aspect ratio of the primary particles constituting the secondary particle X is 7 or more.

### TECHNICAL FIELD

The present invention relates to a metal composite compound, a method for producing a lithium metal composite oxide and a method for producing a metal composite compound.

Priority is claimed on Japanese Patent Application No. 2022-114299, filed Jul. 15, 2022, the content of which is incorporated herein by reference.

### BACKGROUND ART

As a method for producing a positive electrode active material for a lithium secondary battery, for example, there is a method in which a lithium compound and a metal composite compound containing a metal element other than Li are mixed and calcined.

In order to achieve battery characteristics of a lithium secondary battery, such as improvement of cycle characteristics, reduction in resistance, or improvement of output, studies have been conducted to control an average particle diameter, a particle size distribution, a particle shape, or the like of the positive electrode active material within appropriate ranges.

As an example, studies have been conducted to control a particle shape and the like of a metal composite compound serving as a precursor within an appropriate range.

For example, Patent Document 1 discloses a method for producing a nickel-containing hydroxide that suppresses the occurrence of an annual ring-like structure consisting of layers having different densities, which is observed in a cross section of particles of a nickel composite hydroxide, as this structure adversely affects characteristics of a lithium secondary battery.

### CITATION LIST

### Patent Document

Patent Document 1: PCT International Publication No. WO2017/217367A1

### SUMMARY OF INVENTION

### Technical Problem

In order to further improve battery performance of the lithium secondary battery, there is room for further study on an internal structure of particles of the metal composite compound serving as a precursor.

The present invention has been made in view of the above-described circumstances, and an objective of the present invention is to provide a metal composite compound that is a raw material of a positive electrode active material enabling the production of a lithium secondary battery having a high initial efficiency, a method for producing a metal composite compound, and a method for producing a lithium metal composite oxide using the same.

### Solution to Problem

The present invention includes the following aspects.
[1] A metal composite compound containing at least Ni, the metal composite compound including: primary particles; and secondary particles which are aggregates of the primary particles, in which the primary particles constituting the secondary particles have a standard deviation of a minor diameter of 0.1 Å or more and 100 Å or less, the secondary particles include secondary particles X having a high density portion in which the primary particles are aggregated at a high density and a low density portion in which the primary particles are aggregated at a low density, and in a case where a binarized image is obtained by binarizing the high density portion and the low density portion in a scanning electron microscope image of a cross section of the secondary particle X, a standard deviation of a ratio of an area of the low density portion of the secondary particle X, which is obtained from the binarized image, is 0.5% or more and 20% or less, and an aspect ratio of the primary particles constituting the secondary particle X is 7 or more.
[2] The metal composite compound according to [1], in which D₅₀ of the metal composite compound satisfies Expression (1),

$$5 μ m \leq {D}_{50} \leq 20 μ m \qquad ( 1 )$$

(D₅₀ is a particle diameter (μm) at which a cumulative volume from a small particle side is 50% in a case where a total cumulative volume in a cumulative particle size distribution curve obtained by measuring the metal composite compound with a laser diffraction type particle size distribution measuring device is set to 100%).
[3] The metal composite compound according to [1] or [2], in which the metal composite compound is represented by Composition Formula (A),

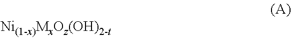

(in Composition Formula (A), 0<x≤0.5, 0≤z≤3, −0.5≤t≤2, and t−z<2 are satisfied, and M is one or more elements selected from the group consisting of Co, Mn, Fe, Cu, Ti, Mg, Al, W, Mo, Nb, Zn, Sn, Zr, Ga, V, B, Si, S, and P).
[4] The metal composite compound according to any one of [1] to [3], in which, in a case where the number of the secondary particles X is denoted by A and the total number of secondary particles included in the metal composite compound is denoted by B, A/B is 0.20 or more.
[5] The metal composite compound according to any one of [1] to [4], in which the low density portion is substantially continuously present in a circumferential direction of the secondary particle X in the cross section of the secondary particle X.
[6] A method for producing a metal composite compound, including: a reaction step of continuously supplying a metal-containing aqueous solution containing Ni and an alkaline aqueous solution to a reaction tank, causing continuous crystal growth, and continuously taking out a metal composite compound,
in which in the reaction step, a flow rate of the alkaline aqueous solution is increased or decreased while continuously supplying the alkaline aqueous solution to the reaction tank, the number of fluctuations in the increase or the decrease per hour is 30 or more and 100 or less, and a rate of change in the flow rate of the alkaline aqueous solution is 3% or more and 20% or less.
[7] A method for producing a lithium metal composite oxide, including: a step of mixing the metal composite compound according to any one of [1] to [5] with a lithium compound and calcining an obtained mixture.

### Advantageous Effects of Invention

According to the present invention, it is possible to provide a metal composite compound that is a raw material of a positive electrode active material enabling the production of a lithium secondary battery having a high initial efficiency, a method for producing a metal composite compound, and a method for producing a lithium metal composite oxide using the same.

### BRIEF DESCRIPTION OF DRAWINGS

FIG. 1 A schematic configuration view showing an example of a lithium secondary battery.

FIG. 2 A schematic view showing an entire configuration of an all-solid-state lithium secondary battery.

FIG. 3 A conceptual diagram of a cross section of a secondary particle.

FIG. 4 A conceptual diagram of a cross section of a secondary particle.

FIG. 5 A conceptual diagram of a cross section of a secondary particle.

FIG. 6 A schematic view for describing a method of measuring an ASD.

FIG. 7 A SEM image of a cross section of one secondary particle included in a metal composite compound produced in Example 1.

FIG. 8 A binarized image of the SEM image of the cross section shown in FIG. 7.

FIG. 9 A diagram in which a diameter (major axis length) is described on the binarized image shown in FIG. 8.

FIG. 10 A diagram in which a grid is superimposed on the binarized image shown in FIG. 8.

FIG. 11 A diagram showing cells overlapping the binarized image in the grid superimposed on the binarized image shown in FIG. 10.

FIG. 12 A view showing an example of a change in a flow rate of an alkaline aqueous solution in a reaction step of a method for producing a metal composite compound according to the present embodiment.

### DESCRIPTION OF EMBODIMENTS

In the present specification, “high initial efficiency” means that a value of an initial efficiency measured by the following method is 80% or more.

In the present specification, a metal composite compound is hereinafter referred to as “MCC”, and a lithium metal composite oxide is hereinafter referred to as “LiMO”.

A positive electrode active material for a lithium secondary battery (cathode active material for lithium secondary batteries) is hereinafter referred to as “CAM”.

A notation “Ni” does not indicate a simple Ni metal, but a Ni element unless particularly otherwise specified. The same applies to notations of other elements such as Co and Mn.

In a case where a numerical range is described as, for example, “1 to 10 μm”, the numerical range means a range from 1 μm to 10 μm and means a numerical range including 1 μm as a lower limit and 10 μm as an upper limit.

### [Calculation of Initial Efficiency of Lithium Secondary Battery]

An initial efficiency of the lithium secondary battery is calculated by producing a lithium secondary battery by the following method.

### (Production of CAM)

An MCC and a lithium hydroxide monohydrate powder are weighed and mixed in a molar ratio of Li/(Ni+Co+M)=1.02 to obtain a mixture. The obtained mixture is calcined at 740° C. for five hours in an oxygen-containing atmosphere to obtain a LiMO.

### (Production of Positive Electrode for Lithium Secondary Battery)

A paste-like positive electrode mixture is prepared by adding and kneading a CAM composed of the LiMO that is produced by the above-described method, a conductive material (acetylene black), and a binder (PVdF) in proportions at which a composition of CAM: conductive material:binder=92:5:3 (mass ratio) is achieved. During the preparation of the positive electrode mixture, N-methyl-2-pyrrolidone is used as an organic solvent.

The obtained positive electrode mixture is applied to a 40 μm-thick Al foil serving as a current collector and dried in a vacuum at 150° C. for eight hours to obtain a positive electrode for a lithium secondary battery. An electrode area of the positive electrode for a lithium secondary battery is set to 1.65 cm².

### (Production of Lithium Secondary Battery)

The following operation is performed in a glove box under an argon atmosphere.

The positive electrode for a lithium secondary battery produced in (Production of Positive Electrode for Lithium Secondary Battery) is placed on a lower lid of a part for a coin type battery R2032 (for example, manufactured by Hohsen Corp.) with an aluminum foil surface facing downward, and a separator (a porous layer made of polyethylene) is placed on the positive electrode for a lithium secondary battery. 300 μl of an electrolytic solution is injected thereinto. As the electrolytic solution, a liquid is used in which LiPF₆ is dissolved at a ratio of 1.0 mol/l in a mixed solution of ethylene carbonate, dimethyl carbonate, and ethyl methyl carbonate mixed in a ratio (volume ratio) of 30:35:35.

Next, metal lithium is used as a negative electrode, and the negative electrode is placed on an upper side of a laminated film separator, covered with an upper lid via a gasket, and caulked by a caulking machine, whereby a lithium secondary battery (coin type half cell R2032) is produced. As the laminated film separator, a laminated film separator having a thickness of 16 μm and having a heat-resistant porous layer laminated on a polyethylene porous film is used.

### (Charge and Discharge Test)

An initial efficiency test is conducted by the following method using the lithium secondary battery produced by the above-described method, and the initial efficiency of the lithium secondary battery is calculated.

### (Measurement Method)

First, the lithium secondary battery produced by the above-described method is left to stand at room temperature for 12 hours to sufficiently impregnate the separator and a positive electrode mixture layer with the electrolytic solution.

Next, at a testing temperature of 25° C., a set current value is set to 0.2CA for both charging and discharging, and each of constant-current constant-voltage charging and constant-current discharging is performed. A maximum charge voltage is set to 4.3V, and a minimum discharge voltage is set to 2.5V. A charge capacity is measured, and the obtained value is defined as an “initial charge capacity” (mAh/g). A discharge capacity is measured, and the obtained value is defined as an “initial discharge capacity” (mAh/g).

In addition, the initial efficiency is calculated by the following expression using the value of the initial discharge capacity and the value of the initial charge capacity.

$$Initial efficiency ( \% ) = initial discharge capacity ( mAh / g ) / initial charge capacity ( mAh / g ) \times 100$$

### <MCC>

The MCC of the present embodiment contains at least Ni. It is preferable that the MCC contains Ni and an element M. Examples of the element M include one or more elements selected from the group consisting of Co, Mn, Fe, Cu, Ti, Mg, Al, W, Mo, Nb, Zn, Sn, Zr, Ga, V, B, Si, S, and P. In addition, the MCC more preferably contains one or more elements selected from the group consisting of Co, Mn, and Al, and still more preferably contains two or more elements selected from the group consisting of Co, Mn, and Al.

When the MCC and a lithium compound are mixed and calcined, a LiMO can be produced.

The MCC contains primary particles and secondary particles which are aggregates of the primary particles. The secondary particles include secondary particles X. The secondary particle X is a secondary particle having a high density portion in which the primary particles are aggregated at a high density and a low density portion in which the primary particles are aggregated at a low density. The MCC may include secondary particles that do not correspond to the secondary particles X. In other words, the MCC may include the secondary particles X and secondary particles different from the secondary particles X.

The MCC is preferably a powder.

The “primary particles” mean particles having no grain boundary in appearance when observed in a visual field at 5,000 to 30,000 times using a scanning electron microscope or the like.

The “secondary particle” is a particle in which the primary particles are aggregated. That is, the secondary particle is an aggregate of the primary particles.

Examples of the MCC include a metal composite oxide or a metal composite hydroxide containing Ni, and a metal composite oxide or a metal composite hydroxide containing Ni and an element M.

### [Method of Acquiring SEM Image of Cross Section of Secondary Particle]

A scanning electron microscope image (hereinafter, SEM image) of a cross section of the secondary particle in the MCC can be acquired by the following method. First, the secondary particles are processed to obtain cross sections. Examples of the method of obtaining the cross sections include a method of obtaining cross sections of the secondary particles by processing the secondary particles with a cross section polisher (hereinafter, sometimes referred to as CP).

Here, a sample of the secondary particles to be subjected to the cross-section processing is randomly selected.

Next, the secondary particles selected above are processed under the following processing conditions using the CP to obtain cross sections.

### <Processing Conditions>

CP: “SM-09010” manufactured by JEOL Ltd.
Gas used: Argon
Acceleration voltage: 5 kV

Among the cross sections of the secondary particles obtained under the above-described processing conditions, a cross section of a secondary particle having a major axis length of D₅₀ (μm)±5% is selected and observed with a secondary electron image of a scanning electron microscope. The cross section of the secondary particle having a major axis length of D₅₀ (μm)±5% can be regarded as a cross section of a secondary particle cut to pass through the vicinity of a center (centroid) of the secondary particle before the processing.

Specific observation conditions are as follows.

Scanning electron microscope: FE-SEM “JSM-IT500HR” manufactured by JEOL Ltd.
Acceleration voltage: 15.0 kV
Irradiation current: 50.0 pA
Focal length: 10.0±1.5 mm

As a resolution of the SEM image of the cross sections of the secondary particles, the number of pixels may be appropriately selected based on specifications of the scanning electron microscope used. With such a number of pixels, values of ASD and MSD can be calculated independently of the number of pixels.

For example, in FE-SEM “JSM-IT500HR” manufactured by JEOL Ltd., the number of image pickup pixels can be selected from 640×480 (300,000 pixels), 1280×960 (1 million pixels), 2560×1920 (5 million pixels), and 5120×3840 (20 million pixels).

In the present embodiment, a resolution in a range of 1 million pixels to 5 million pixels is preferable.

The primary particles constituting the secondary particles have a plate-like, rectangular, or needle-like shape in which a minor diameter and a major diameter can be confirmed. The primary particles constituting the secondary particles have a standard deviation of a minor diameter of 0.1 to 100 Å. In addition, the primary particles constituting the secondary particles X have an aspect ratio of 7 or more.

Hereinafter, there are cases where the standard deviation of the minor diameter is referred to as “minor diameter standard deviation (MSD)”.

### [Method of Measuring MSD]

The minor diameters of the primary particles constituting the secondary particles are measured using the SEM image of the cross section of the secondary particle acquired by [Method of Acquiring SEM Image of Cross Section of Secondary Particle] described above.

Specifically, in the acquired SEM image of the cross section of the secondary particle, minor diameters of 30 or more primary particles constituting the same secondary particle in a visual field at a magnification of 20,000 times or more are measured. A shorter one of orthogonal lines within a contour of the primary particle is defined as a minor diameter. At this time, the primary particles to be measured are randomly selected from primary particles visible in a foreground of the visual field, with three or more sides of the contour not overlapping with other primary particles, and the minor diameters of the primary particles constituting the secondary particles are measured to calculate the MSD.

The MSD of the primary particles constituting the secondary particles is preferably 0.1 Å or more, more preferably 3 Å or more, and still more preferably 6 Å or more. The MSD is preferably 80 Å or less and still more preferably 60 Å or less. The MSD is preferably 0.1 to 80 Å, more preferably 3 to 80 Å, and still more preferably 6 to 60 Å.

In the SEM image of the cross section of the secondary particle acquired by [Method of Acquiring SEM Image of Cross Section of Secondary Particle] described above, the secondary particle having a high density portion in which the primary particles are aggregated at a high density and a low density portion in which the primary particles are aggregated at a low density is the secondary particle X. In a case where a binarized image is obtained by binarizing a high density portion and a low density portion in a SEM image of a cross section of the secondary particle X, a standard deviation of a ratio of an area of the low density portion obtained from the binarized image is 0.5% to 20%. In the present specification, there are cases where the standard deviation of the ratio of the area of the low density portion obtained from the binarized image is referred to as “area standard deviation (ASD)”.

The “high density portion” refers to a region that turns white in a binarized image obtained by binarizing a 256-gradation image of the SEM image of the cross section of the secondary particle acquired by [Method of Acquiring SEM Image of Cross Section of Secondary Particle] described above with a threshold set to 90.

The “low density portion” refers to a region that turns black in the binarized image obtained by binarizing the 256-gradation image of the SEM image of the cross section of the secondary particle acquired by [Method of Acquiring SEM Image of Cross Section of Secondary Particle] described above with the threshold set to 90.

The SEM image of the cross section of the secondary particle used for obtaining the binarized image is set to a magnification at which the entire cross section of one secondary particle is included in one visual field. Such a magnification is, for example, 2,000 to 20,000 times. When calculating the ASD, in a case where the magnification is such that the entire cross section of one secondary particle is included in one visual field, the value of the ASD can be calculated independently of the magnification.

### [Method of Acquiring Binarized Image]

Image analysis software “Image J” is used for binarization processing.

First, the SEM image of the cross section of the secondary particle acquired by [Method of Acquiring SEM Image of Cross Section of Secondary Particle] described above is converted into a 256-gradation image using image analysis software “Image J”.

Next, a threshold for conversion into two gradations of white and black is set to 90. Regions with a threshold of 90 or more are converted to white, and regions with a threshold of less than 90 are converted to black. An upper limit of the threshold is set to a maximum value (255).

In such a method, the ASD can be calculated independently of the version or setting of the image analysis software.

FIG. 8 is a binarized image acquired by importing a SEM image of a cross section of one secondary particle included in an MCC obtained in Example 1 described later into Image J, obtaining an image of 256 gradations, and setting the threshold to 90.

In the binarized image shown in FIG. 8, a region that has turned white is a high density portion, and a region that has turned black observed in the cross section of the secondary particle is a low density portion.

In the binarized image, it is preferable that the low density portion is present substantially continuously in a circumferential direction of the secondary particle.

For example, in the cross section of the secondary particle, a high density portion is observed at a center portion, and a low density portion is observed outside the center portion on an outer periphery of the center portion, and a high density portion is observed on an outermost layer of the secondary particle from an outside of the low density portion.

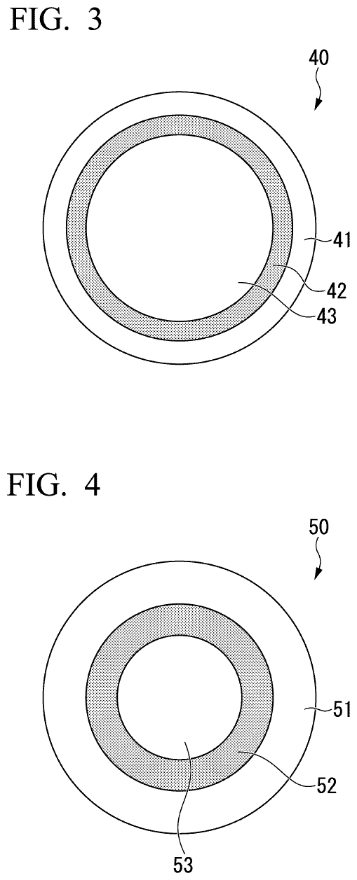

FIGS. 3 to 5 are conceptual diagrams of a cross section of one secondary particle X.

A secondary particle 40 shown in FIG. 3 includes a first high density portion 43 at a center portion, a low density portion 42 outside the center portion, and a second high density portion 41 outside the low density portion 42.

The low density portion may have an ASD within a range of the present embodiment. For example, as in a secondary particle 50 shown in FIG. 4, a first high density portion 53 may be provided at a center portion, a low density portion 52 may be provided outside the center portion, a second high density portion 51 may be provided outside the low density portion 52, and the low density portion 52 may be formed in the vicinity of the center portion.

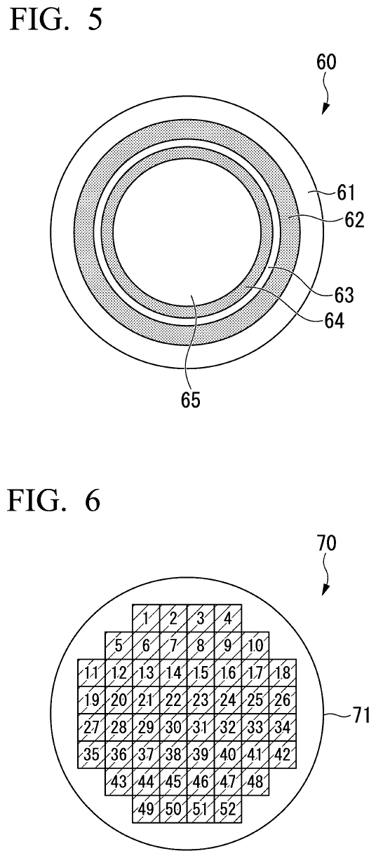

The low density portion may be present in a form observed in an annual ring shape in the cross section of the secondary particle X. For example, in a secondary particle 60 shown in FIG. 5, a first high density portion 65 may be provided at a center portion, a low density portion 64 may be provided outside the center portion, a second high density portion 63 may be provided outside the low density portion 64, a second low density portion 62 may be provided outside the high density portion 63, and a third high density portion 61 may be provided outside the low density portion 62.

### [Method of Measuring ASD]

For the binarized image obtained in [Method of Acquiring Binarized Image] described above, one secondary particle is randomly selected, and a diameter (major axis length) of the secondary particle is measured.

Next, a grid (mesh) in which a length of one side is 1/10 of a major diameter of the secondary particle is assumed.

For example, in a case where the diameter of the secondary particle is 10 μm, a square having a length of one side of 1 μm is regarded as one cell.

The grid is superimposed on the binarized image, and for all of 30 or more overlapping cells among cells where each cell completely overlaps the binarized image, a proportion of a black area in each cell is measured. The proportion of the black area in each cell can be obtained using a tool of Image J.

Description is provided using a schematic diagram indicated by reference numeral 70 shown in FIG. 6. For all of 30 or more overlapping cells among cells 1 to 52 that completely overlap the binarized image 71, a proportion of a black area in each cell is measured.

A standard deviation of the proportion of the black area is defined as ASD.

The ASD is preferably 1.0% or more and more preferably 2.0% or more. The ASD is preferably 18% or less and more preferably 16% or less. The ASD is preferably 1.0% to 18% and more preferably 2.0% to 16%.

### [Method of Measuring Aspect Ratio]

A minor diameter and a major diameter of the primary particles constituting the secondary particle X are measured using the SEM image of the cross section of the secondary particle X acquired by [Method of Acquiring SEM Image of Cross Section of Secondary Particle] described above.

Specifically, in the acquired SEM image of the cross section of the secondary particle X, major diameters and minor diameters of 30 or more primary particles constituting the same secondary particle X in a visual field at a magnification of 20,000 times or more are measured. Within a contour of the primary particle, the longer of lines orthogonal to each other is defined as a major diameter, and the shorter is defined as a minor diameter. At this time, the primary particles to be measured are randomly selected from primary particles visible in a foreground of the visual field, with three or more sides of the contour not overlapping with other primary particles, and the major diameters and the minor diameters are measured.

A ratio of the major diameter to the minor diameter, that is, major diameter/minor diameter, is defined as an aspect ratio.

An aspect ratio of the primary particles constituting the secondary particle X is preferably 7.0 or more, more preferably 7.1 or more, and still more preferably 7.2 or more. The aspect ratio is preferably 10.0 or less, more preferably 9.9 or less, and still more preferably 9.8 or less. The aspect ratio is preferably 7.0 to 10.0, more preferably 7.1 to 9.9, and still more preferably 7.2 to 9.8.

In a case where the MCC including the secondary particles constituted by the primary particles having an MSD in the above-described range is mixed with a lithium compound and calcined, uniform calcination is facilitated.

Furthermore, in a case where the MCC including the secondary particles X in which the aspect ratio of the primary particles is in the above-described range and the ASD is in the above-described range is mixed with a lithium compound and calcined, Li is likely to permeate through the low density portion, facilitating uniform calcination.

A CAM obtained by using such a MCC as a raw material is less likely to cause uneven reactions and is likely to be formed into uniform particles. In a lithium secondary battery including such a CAM, lithium ions can smoothly move in the battery, and thus an initial efficiency is likely to be high.

It is preferable that D₅₀ of the MCC satisfies Expression (1).

$$5 μ m \leq {D}_{50} \leq 20 μ m \qquad ( 1 )$$

(D₅₀ is a particle diameter (μm) at which a cumulative volume from a small particle side is 50% in a case where a total cumulative volume in a cumulative particle size distribution curve obtained by measuring the MCC with a laser diffraction type particle size distribution measuring device is set to 100%).

In a case where the D₅₀ of the MCC is 5 μm or more, a low density portion is likely to be formed, and a permeation path of Li is likely to be formed. As a result, the initial efficiency of the lithium secondary battery is likely to be high.

In a case where the D₅₀ of the MCC is 20 μm or less, coarse particles are less likely to be generated, and uneven reactions with the Li compound are less likely to occur. As a result, the initial efficiency of the lithium secondary battery is likely to be high.

### [Method of Acquiring Cumulative Particle Size Distribution Curve]

A “cumulative volume particle size” is a value measured by a laser diffraction scattering method. The powder of the MCC is put into 0.25 ml of a 10 mass % sodium hexametaphosphate aqueous solution at a ratio at which transmittance of the particle size distribution measuring device is 80±5%, thereby obtaining a dispersion liquid in which the powder of the MCC is dispersed.

Next, a particle size distribution of the obtained dispersion liquid is measured using a laser diffraction scattering particle size distribution measuring device (for example, Microtrac MT3300EXII manufactured by MicrotracBEL Corp.) to obtain a volume-based cumulative particle size distribution curve. D₅₀ (μm) is obtained from the obtained cumulative particle size distribution curve.

The D₅₀ of the MCC is preferably 6 μm or more and more preferably 7 μm or more. The D₅₀ is preferably 18 μm or less and more preferably 16 μm or less. The D₅₀ is preferably 6 to 18 μm and more preferably 7 to 16 μm.

### [Method of Calculating A/B]

In a plurality of visual fields of the SEM image of the cross section of the secondary particle acquired by [Method of Acquiring SEM Image of Cross Section of Secondary Particle] described above, in a case where the number of secondary particles X is denoted by A and the total number of secondary particles included in the MCC is denoted by B, A/B is preferably 0.20 or more, more preferably 0.22 or more, and still more preferably 0.24 or more. In addition, A/B is preferably 0.50 or less, more preferably 0.48 or less, and still more preferably 0.46 or less.

The above-described upper limit and lower limit of A/B can be randomly combined. A/B is preferably 0.20 to 0.50, more preferably 0.22 to 0.48, and still more preferably 0.24 to 0.46.

In a case where the MCC in which A/B is in the above-described range is used, the initial efficiency of the lithium battery is likely to be high.

The MCC is preferably represented by Composition Formula (A).

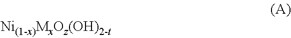

(in Composition Formula (A), 0<x≤0.5, 0≤z≤3, and −0.5≤t≤2 are satisfied, and M is one or more elements selected from the group consisting of Co, Mn, Fe, Cu, Ti, Mg, Al, W, Mo, Nb, Zn, Sn, Zr, Ga, V, B, Si, S, and P).

The MCC is preferably a hydroxide having Composition Formula (A)-1.

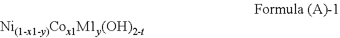

(in Composition Formula (A)-1, 0≤x1≤0.5, 0≤y≤0.5, 0<x1+y≤0.5, and −0.5≤t<2 are satisfied, and M1 is one or more elements selected from the group consisting of Mn, Fe, Cu, Ti, Mg, Al, Zn, Sn, Zr, Nb, Ga, W, Mo, B, Si, S, and P).

In Composition Formula (A), M is preferably one or more elements selected from the group consisting of Co, Mn, Al, W, B, Nb, and Zr. In addition, M preferably includes one or more elements selected from the group consisting of Co, Mn, and Al, and more preferably includes two or more elements selected from the group consisting of Co, Mn, and Al. In Composition Formula (A)-1, M1 preferably includes one or more elements selected from the group consisting of Mn and Al.

(x)

From the viewpoint of increasing the initial efficiency, x is preferably 0.01 or more, more preferably 0.02 or more, and still more preferably 0.03 or more.

In addition, x is preferably 0.44 or less, more preferably 0.42 or less, and still more preferably 0.40 or less.

The upper limit and lower limit of x can be randomly combined.

Composition Formula (A) preferably satisfies 0.01≤x≤0.44, more preferably satisfies 0.02≤x≤0.42, and still more preferably satisfies 0.03≤x≤0.40.

(x1)

From the viewpoint of increasing the initial efficiency, x1 is preferably 0.01 or more, more preferably 0.02 or more, and still more preferably 0.03 or more.

In addition, x1 is preferably 0.44 or less, more preferably 0.42 or less, and still more preferably 0.40 or less.

The upper limit and lower limit of x1 can be randomly combined.

Composition Formula (A)-1 preferably satisfies 0.01≤x1≤0.44, more preferably satisfies 0.02≤x1≤0.42, and still more preferably satisfies 0.03≤x1≤0.40.

(y)

From the viewpoint of increasing the initial efficiency, y is preferably 0.01 or more, more preferably 0.02 or more, and particularly preferably 0.03 or more.

In addition, y is preferably 0.44 or less, more preferably 0.42 or less, and particularly preferably 0.40 or less.

The upper limit and lower limit of y can be randomly combined.

Composition Formula (A)-1 preferably satisfies 0.01≤y≤0.44, more preferably satisfies 0.02≤y≤0.42, and still more preferably satisfies 0.03≤y≤0.40.

$$( x 1 + y )$$

From the viewpoint of increasing the initial efficiency, x1+y is preferably 0.01 or more, more preferably 0.02 or more, and still more preferably 0.03 or more.

In addition, x1+y is preferably 0.44 or less, more preferably 0.42 or less, and still more preferably 0.40 or less.

The upper limit and lower limit of x1+y can be randomly combined.

Composition Formula (A)-1 preferably satisfies 0.01≤x1+y≤0.44, more preferably satisfies 0.02≤x1+y≤0.42, and still more preferably satisfies 0.03≤x1+y≤0.40.

(z)

z is preferably 0.02 or more, more preferably 0.03 or more, and still more preferably 0.05 or more.

z is preferably 2.8 or less, more preferably 2.6 or less, and still more preferably 2.4 or less.

The upper limit and lower limit of z can be randomly combined.

Composition Formula (A) preferably satisfies 0≤z≤2.8, more preferably satisfies 0.02≤z≤2.8, still more preferably satisfies 0.03≤z≤2.6, and particularly preferably satisfies 0.05≤z≤2.4.

(t)

t is preferably-0.45 or more, more preferably-0.40 or more, and still more preferably-0.35 or more.

t is preferably 1.8 or less, more preferably 1.6 or less, and still more preferably 1.4 or less. The upper limit and lower limit of t can be randomly combined.

Composition Formula (A) or Composition Formula (A)-1 preferably satisfies-0.45≤t≤1.8, more preferably satisfies-0.40≤t≤1.6, and still more preferably satisfies −0.35≤t≤1.4.

Composition Formula (A) preferably satisfies 0.01≤x≤0.44, 0≤z≤2.8, and −0.45≤t≤1.8.

Composition Formula (A)-1 preferably satisfies 0.01≤x1≤0.44, 0.01≤y≤0.44, 0.01≤x1+y≤0.44, and −0.45≤t≤1.8.

### [Composition Analysis of MCC]

Composition analysis of the MCC can be measured using an ICP emission spectrometer after dissolving the powder of the obtained MCC in hydrochloric acid.

As the ICP emission spectrometer, for example, Optima 8300 manufactured by Perkin Elmer Inc. can be used.

### <Method for Producing MCC>

A method for producing the MCC is a method including a reaction step of continuously supplying a metal-containing aqueous solution containing Ni and an alkaline aqueous solution to a reaction tank, causing continuous crystal growth, and continuously taking out an MCC.

Examples of metal elements other than Ni, which may be contained in the metal-containing aqueous solution, include the element M described above.

Examples of the metal-containing aqueous solution containing Ni include a metal-containing aqueous solution containing Ni, Co, and Mn, and a metal-containing aqueous solution containing Ni, Co, and Al.

The metal-containing aqueous solution containing Ni, Co, and Mn is a mixed solution of a nickel salt solution, a cobalt salt solution, and a manganese salt solution.

The metal-containing aqueous solution containing Ni, Co, and Al is a mixed solution of a nickel salt solution, a cobalt salt solution, and an aluminum salt solution.

As a nickel salt which is a solute of the nickel salt solution, for example, one or more of nickel sulfate, nickel nitrate, nickel chloride, and nickel acetate can be used.

As a cobalt salt which is a solute of the cobalt salt solution, for example, one or more of cobalt sulfate, cobalt nitrate, cobalt chloride, and cobalt acetate can be used.

As a manganese salt which is a solute of the manganese salt solution, for example, one or more of manganese sulfate, manganese nitrate, manganese chloride, and manganese acetate can be used.

As an aluminum salt which is a solute of the aluminum salt solution, for example, aluminum sulfate can be used.

Each metal salt is used in such a ratio that an atomic ratio of each metal elements corresponding to a composition ratio of Composition Formula (A) is (1-x):x.

In addition, a solvent for the nickel salt solution, the cobalt salt solution, the manganese salt solution, and the aluminum salt solution is water. That is, the nickel salt solution, the cobalt salt solution, the manganese salt solution, and the aluminum salt solution are aqueous solutions.

The metal-containing aqueous solution containing Ni and the alkaline aqueous solution are reacted by a continuous co-precipitation method described in JP-A-2002-201028 to produce a metal composite hydroxide.

The alkaline aqueous solution is, for example, sodium hydroxide or potassium hydroxide.

The alkaline aqueous solution is added in order to adjust a pH value of the metal-containing aqueous solution containing Ni.

The pH value in the present specification is defined as a value measured when a temperature of the mixed solution is 40° C. A pH of the mixed solution is measured when the temperature of the mixed solution sampled from the reaction tank reaches 40° C.

In the reaction step, a flow rate of the alkaline aqueous solution is increased or decreased while continuously supplying the alkaline aqueous solution to the reaction tank. In this case, it is preferable that the increase or decrease in the flow rate of the alkaline aqueous solution is continuously performed a plurality of times. As a result, the ASD and the MSD can be adjusted to be in the above-described ranges.

The sentence “the flow rate of the alkaline aqueous solution is increased” means increasing from a current flow rate (for example, S1) of the alkaline aqueous solution to a set flow rate (for example, S2) greater than the current flow rate.

The sentence “the flow rate of the alkaline aqueous solution is decreased” means decreasing from a current flow rate (for example, S2) of the alkaline aqueous solution to a set flow rate (for example, S3) smaller than the current flow rate.

Here, since the alkaline aqueous solution is continuously supplied to the reaction tank, any flow rate is a value greater than 0.

The sentence “the increase or decrease in the flow rate of the alkaline aqueous solution is continuously performed a plurality of times” means that the increase or decrease in the flow rate of the alkaline aqueous solution is performed a plurality of times until an end of the reaction step, and in FIG. 12, means that the flow rate of the alkaline aqueous solution is continuously and repeatedly changed in the order of S3, S2, S3, and S2.

The flow rate of the alkaline aqueous solution supplied to the reaction tank in the reaction step will be described with reference to FIG. 12. FIG. 12 is a diagram showing an example of a change in the flow rate (unit: L/h) of the alkaline aqueous solution in the reaction step. In FIG. 12, a horizontal axis represents time, and a vertical axis represents the flow rate of the alkaline aqueous solution.

In FIG. 12, S1 is an initial flow rate of the alkaline aqueous solution. S1 is an initial set value when the alkaline aqueous solution is supplied to the reaction tank, and S1 is a value greater than 0. S2 indicates a flow rate set to increase the flow rate of the alkaline aqueous solution from S1, and S3 indicates a flow rate set to decrease the flow rate of the alkaline aqueous solution from S2.

In FIG. 12, an example in which the flow rate of the alkaline aqueous solution is repeatedly increased or decreased between S2 and S3 is shown. However, a new flow rate S4 may be set after reaching S3, and a new flow rate S5 may be set after reaching S2. For example, the flow rate may be increased from S3 to S4 after being increased and decreased in order of S1, S2, and S3, or the flow rate may be decreased from S2 to S5 after being increased and decreased in order of S1, S2, S3, and S2. In addition, S2 or S3 may have the same value as S1. For example, in a case where S3 has the same value as S1, the flow rate may be decreased from S2 to S1 (=S3) after being increased from S1 to S2, and then may be increased from S1 to S2 again.

The number of fluctuations is calculated as one time when the flow rate is increased from the current flow rate and is further decreased until the flow rate reaches the decreased flow rate. For example, in FIG. 12, in a case where the flow rate is increased from S1 and reaches S2 and the flow rate is decreased from S2 and reaches S3, a cycle from S1 to S3 is counted as one fluctuation. That is, S1→S2→S3 is a “first” fluctuation.

Thereafter, a cycle in which the flow rate is increased from S3 and reaches S2 and the flow rate is decreased from S2 and reaches S3 again is counted as one fluctuation. That is, initial S3→S2→S3 is a “second” fluctuation.

In a case where the flow rate of the alkaline aqueous solution is increased or decreased while continuously supplying the alkaline aqueous solution to the reaction tank, a pH instantaneously fluctuates in the vicinity of an inlet of the alkaline aqueous solution. In this case, a pH in a periphery of the metal composite hydroxide in a growth process in which the metal composite hydroxide retained in the reaction tank instantaneously fluctuates. In a case where the pH in the periphery of the metal composite hydroxide is high, a high density portion is formed, and in a case where the pH is low, a low density portion is formed. In addition, since a growth rate and a growth direction of the primary particles of the metal composite hydroxide differ depending on the pH in the periphery, the minor diameter of the primary particles, that is, the MSD can be controlled by changing the pH in the periphery the metal composite hydroxide in the growth process. As a result, the initial efficiency can be improved.

The number of fluctuations per hour in the increase or decrease in the flow rate of the alkaline aqueous solution is 30 to 100. The number of fluctuations is preferably 40 or more and more preferably 50 or more. The number of fluctuations is preferably 90 times or less and more preferably 80 times or less. The number of fluctuations is preferably 40 to 90 and more preferably 50 to 80.

In a case where the number of fluctuations is equal to or greater than the lower limit, the time during which the periphery of the metal composite hydroxide in the growth process is maintained in the same pH range is unlikely to be long. In this case, the time during which the primary particles are maintained in the pH region where the primary particles are hardly grown and the time during which the primary particles are maintained in the pH region where the primary particles are easily grown are unlikely to be long. As a result, the degree of growth of the primary particles is less likely to vary, and the MSD is less likely to be excessive. Therefore, the initial efficiency can be improved.

In a case where the number of fluctuations is equal to or smaller than the upper limit, the pH of the periphery appropriately fluctuates during the growth of the primary particles, and thus a low density portion and a high density portion are likely to be formed. In addition, a growth cycle of the primary particles of the low density portion does not become too short, and a layer thickness of the low density portion does not become too small. Furthermore, since the pH in the reaction tank is less likely to fluctuate, variation in nucleation of the primary particles is less likely to occur. As a result, the ASD is less likely to be too small. Therefore, the initial efficiency can be improved.

In the reaction step, a rate of change in the flow rate of the alkaline aqueous solution is 3% to 20%.

The rate of change in the flow rate of the alkaline aqueous solution refers to a value obtained by averaging absolute values of the rate of change in each change in flow rate performed from the time when the flow rate was started to be changed from the initial set flow rate up to one hour. For example, in the case of FIG. 12, the absolute value of the rate of change in flow rate in the increase from S1 to S2 is calculated by “IS2−S1l/S1×100”. The absolute value of the rate of change in flow rate in the decrease from S2 to S3 is calculated by “IS2-S3l/S1×100”. The same calculation is performed for subsequent changes in flow rate, the absolute value of the change rate for each flow rate is calculated, and the average value thereof is defined as the “rate of change in the flow rate of the alkaline aqueous solution”.

The rate of change is preferably 5% or more and more preferably 7% or more. The rate of change is preferably 18% or less and more preferably 16% or less. The rate of change is preferably 5% to 18% and more preferably 7% to 16%.

In a case where the rate of change is equal to or greater than the lower limit, that is, in a case where a fluctuation range is not too small, a difference in pH is appropriately generated in the periphery of the metal composite hydroxide in the growth process, and thus a low density portion and a high density portion are likely to be formed. Furthermore, growth cycles of the low density portion and the high density portion do not become too short and the layer thickness of the low density portion does not become too small, so that the ASD is less likely to be too small. Therefore, the initial efficiency can be improved.

In a case where the rate of change is equal to or smaller than the upper limit, that is, in a case where the fluctuation range is not too large, variation in the degree of growth of the primary particles is less likely to occur, and the MSD is less likely to be excessive. Therefore, the initial efficiency can be improved.

It is preferable that a complexing agent is supplied in addition to the metal-containing aqueous solution containing Ni and the alkaline aqueous solution. In a case where the complexing agent is continuously supplied to the reaction tank, for example, Ni, Co, and Mn react with each other to produce Ni_{(1-x1-y)}Coₓ₁Mn_{y}(OH)₂. In addition, Ni, Co, and Al react with each other to produce Ni_{(1-x1-y)}Coₓ₁Al_{y}(OH)₂.

The complexing agent is a compound capable of forming a complex with nickel ions, cobalt ions, aluminum ions, and manganese ions in an aqueous solution. Examples of the complexing agent include ammonium ion donors (ammonium salts such as ammonium hydroxide, ammonium sulfate, ammonium chloride, ammonium carbonate, and ammonium fluoride), hydrazine, ethylenediaminetetraacetic acid, nitrilotriacetic acid, uracildiacetic acid, and glycine.

An amount of the complexing agent contained in a mixed solution containing the metal-containing aqueous solution containing Ni and the complexing agent is, for example, such that a molar ratio to the total number of moles of the metal salts is more than 0 and 2.0 or less. An amount of the complexing agent contained in a mixed solution containing the nickel salt solution, the cobalt salt solution, the manganese salt solution is, for example, a molar ratio to the total number of moles of the metal salts is more than 0 and 1.0 or less.

During the reaction, a temperature of the reaction tank is controlled, for example, within a range of 20° C. to 80° C., preferably 30° C. to 70° C.

In addition, during the reaction, a pH value in the reaction tank is controlled, for example, within a range of 9 to 14 and preferably 10 to 13.

Flow rates of the metal-containing aqueous solution containing Ni, the alkaline aqueous solution, and the complexing agent are controlled such that the pH value in the reaction tank is within the above-described range.

In a case of controlling the pH in the reaction tank, the alkaline aqueous solution is added while the flow rate thereof is changed 30 to 100 times and the rate of change in the flow rate is changed in a range of 3% to 20%.

The materials in the reaction tank are appropriately stirred and mixed together.

As the reaction tank which is used in the continuous co-precipitation method, an overflow type reaction tank can be used to separate formed reaction precipitates.

In addition to the control of the above conditions, various gases such as an inert gas such as nitrogen, argon, and carbon dioxide, an oxidizing gas such as air and oxygen, or a mixed gas thereof may be supplied into the reaction tank to control an oxidation state of an obtained reaction product.

Specifically, an inside of the reaction tank may be an inert atmosphere. In a case where the inside of the reaction tank is an inert atmosphere, metal elements that are more easily oxidized than Ni among the metal elements contained in the mixed solution are prevented from aggregating prior to Ni. Therefore, a uniform MCC is obtained.

After the above reaction, the obtained reaction product is washed with water and then dried to obtain a metal composite hydroxide which is an MCC.

In a case where the MCC is a metal composite oxide, the metal composite hydroxide is oxidized to produce the metal composite oxide.

As a heating time for oxidation, the total time taken from the start of temperature rise to the end of temperature holding after a temperature is reached is preferably set to 1 to 30 hours. A heating temperature for oxidation is preferably 400° C. to 700° C.

In a case of carrying out the oxidation in the above-described ranges of the heating time and the heating temperature, it is possible to obtain a metal composite oxide in which a particle shape (MSD, ASD, aspect ratio, D₅₀, and the like) of the metal composite hydroxide is maintained.

### [Method for Producing Lithium Metal Composite Oxide]

A method for producing a LiMO includes a step of mixing an MCC and a lithium compound and calcining an obtained mixture (calcining step).

As the lithium compound, one or more selected from the group consisting of lithium carbonate, lithium hydroxide, and lithium hydroxide monohydrate can be used.

The lithium compound and the MCC are mixed in consideration of a composition ratio of a final target product to obtain the mixture of the lithium compound and the MCC.

### [Calcining Step]

The obtained mixture is calcined at a calcining temperature of 500° C. to 1,000° C. in, for example, an oxygen-containing atmosphere. The mixture is calcined, whereby LiMO crystals grow.

The calcining temperature in the present specification is a temperature of an atmosphere in a calcining furnace and means a highest temperature of a holding temperatures (highest holding temperature).

In a case where the calcining step includes a plurality of calcining steps, the calcining temperature means a temperature of a stage in which calcining is performed at the highest holding temperature among stages.

Specifically, the calcining temperature is preferably 550° C. to 980° C. and preferably 600° C. to 960° C.

In addition, a time for holding the calcining temperature may be 0.1 to 20 hours, and is preferably 0.5 to 10 hours.

In addition, it is preferable that the mixture is calcined in an oxygen-containing atmosphere. Specifically, it is preferable to introduce oxygen gas to create an oxygen-containing atmosphere in the calcining furnace.

As the calcining furnace, a tunnel furnace, a roller hearth kiln, a rotary kiln, or the like can be used.

After the calcining step, a calcined product obtained by the calcination is appropriately crushed and sieved to obtain the LiMO.

### <Lithium Secondary Battery>

A positive electrode for a lithium secondary battery, which is suitable in a case where the LiMO is used as a CAM, will be described. Hereinafter, the positive electrode for a lithium secondary battery will be referred to as a positive electrode in some cases.

Furthermore, a lithium secondary battery suitable as a positive electrode application will be described.

An example of the lithium secondary battery that is suitable in a case where the LiMO is used as a CAM includes a positive electrode, a negative electrode, a separator interposed between the positive electrode and the negative electrode, and an electrolytic solution disposed between the positive electrode and the negative electrode.

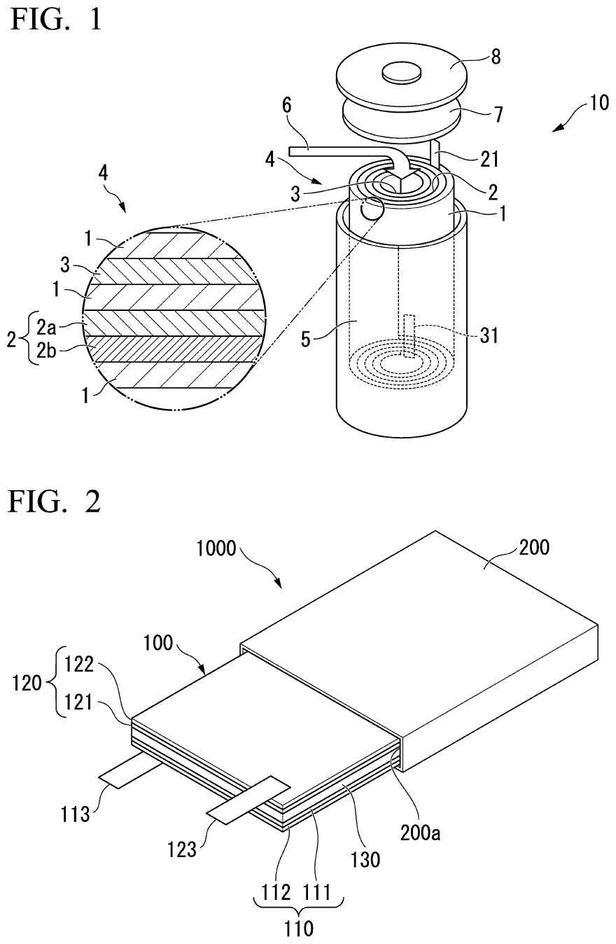

FIG. 1 is a schematic view showing the example of the lithium secondary battery. For example, a cylindrical lithium secondary battery 10 is produced as described below.

First, as shown in a partially enlarged view of FIG. 1, a pair of separators 1 having a strip shape, a strip-shaped positive electrode 2 having a positive electrode lead 21 at one end, and a strip-shaped negative electrode 3 having a negative electrode lead 31 at one end are stacked in order of the separator 1, the positive electrode 2, the separator 1, and the negative electrode 3 and are wound to form an electrode group 4.

The positive electrode 2 includes, for example, a positive electrode active material layer 2a containing the CAM and a positive electrode current collector 2b having the positive electrode active material layer 2a formed on one surface thereof. The positive electrode 2 can be produced by first preparing a positive electrode mixture containing the CAM, a conductive material, and a binder, and supporting the positive electrode mixture on one surface of the positive electrode current collector 2b to form a positive electrode active material layer 2a.

Examples of the negative electrode 3 include an electrode in which a negative electrode mixture containing a negative electrode active material (not shown) is supported on a negative electrode current collector, and an electrode consisting of a negative electrode active material alone, and the negative electrode 3 can be produced in a manner similar to that for the positive electrode 2.

Next, the electrode group 4 and an insulator (not shown) are accommodated in a battery can 5, a can bottom is then sealed, the electrode group 4 is impregnated with an electrolytic solution 6, and an electrolyte is disposed between the positive electrode 2 and the negative electrode 3. Furthermore, an upper portion of the battery can 5 is sealed with a top insulator 7 and a sealing body 8, whereby the lithium secondary battery 10 can be produced.

Examples of a shape of the electrode group 4 include a columnar shape in which a cross-sectional shape when the electrode group 4 is cut in a direction perpendicular to a winding axis becomes a circle, an ellipse, a rectangle, or a rectangle with rounded corners.

In addition, as a shape of the lithium secondary battery having the electrode group 4, a shape defined by IEC60086, which is a standard for a battery defined by the International Electrotechnical Commission (IEC), or by JIS C 8500 can be adopted. Examples thereof include shapes such as a cylindrical shape or a square shape.

Furthermore, the lithium secondary battery is not limited to the wound type configuration, and may have a stacked type configuration in which a stacked structure of a positive electrode, a separator, a negative electrode, and a separator is repeatedly stacked. A so-called coin type battery, a button type battery, and a paper type (or sheet type) battery are exemplary examples of the stacked type lithium secondary battery.

For the positive electrode, the separator, the negative electrode, and the electrolytic solution constituting the lithium secondary battery, for example, the configurations, materials, and production methods described in to of WO2022/113904A1 can be used.

### <All-Solid-State Lithium Secondary Battery>

The LiMO can be used as a CAM of an all-solid-state lithium secondary battery.

FIG. 2 is a schematic view showing an example of the all-solid-state lithium secondary battery. An all-solid-state lithium secondary battery 1000 shown in FIG. 2 has a laminate 100 having a positive electrode 110, a negative electrode 120, and a solid electrolyte layer 130 and an exterior body 200 accommodating the laminate 100. In addition, the all-solid-state lithium secondary battery 1000 may have a bipolar structure in which a CAM and a negative electrode active material are disposed on both sides of a current collector. As specific examples of the bipolar structure, for example, the structures described in JP-A-2004-95400 are exemplary examples.

The positive electrode 110 has a positive electrode active material layer 111 and a positive electrode current collector 112. The positive electrode active material layer 111 contains the CAM and a solid electrolyte. In addition, the positive electrode active material layer 111 may contain a conductive material and a binder.

The negative electrode 120 has a negative electrode active material layer 121 and a negative electrode current collector 122. The negative electrode active material layer 121 contains a negative electrode active material. In addition, the negative electrode active material layer 121 may contain a solid electrolyte and a conductive material.

The laminate 100 may have an external terminal 113 that is connected to the positive electrode current collector 112 and an external terminal 123 that is connected to the negative electrode current collector 122. In addition, the all-solid-state lithium secondary battery 1000 may have a separator between the positive electrode 110 and the negative electrode 120.

The all-solid-state lithium secondary battery 1000 further has an insulator (not shown) that insulates the laminate 100 and the exterior body 200 from each other and a sealant (not shown) that seals an opening portion 200a of the exterior body 200.

As the exterior body 200, a container formed of a highly corrosion-resistant metal material such as aluminum, stainless steel, or nickel-plated steel can be used. In addition, as the exterior body 200, a container obtained by processing a laminate film having at least one surface subjected to a corrosion resistant process into a bag shape can also be used.

Example of a shape of the all-solid-state lithium secondary battery 1000 include shapes such as a coin type, a button type, a paper type (or a sheet type), a cylindrical type, a square type, and a laminate type (pouch type).

As an example of the all-solid-state lithium secondary battery 1000, a form in which one laminate 100 is provided is shown in the drawings, but the present embodiment is not limited thereto. The all-solid-state lithium secondary battery 1000 may have a configuration in which the laminate 100 is used as a unit cell and a plurality of unit cells (laminates 100) are sealed inside the exterior body 200.

For the all-solid state lithium secondary battery, for example, the configurations, materials, and production methods described in to of WO2022/113904A1 can be used.

In the lithium secondary battery having the above-described configuration, since the above-described MCC is used as a raw material for the CAM, the initial efficiency of the lithium secondary battery using the CAM can be improved.

The present invention has the following aspects.
[10] An MCC containing at least Ni, the MCC including: primary particles; and secondary particles which are aggregates of the primary particles, in which the primary particles constituting the secondary particles have an MSD of 0.1 to 80 A, the secondary particles include secondary particles X, the secondary particle X has an ASD of 2.0 to 16%, and an aspect ratio of the primary particles constituting the secondary particle X is 7.2 to 9.8.
[11] The MCC according to [10], in which D₅₀ of the MCC satisfies Expression (1′),

$$7 μ m \leq {D}_{50} \leq 16 μ m \qquad ( {1}^{′} )$$

[12] The MCC according to or [11], in which the MCC is represented by Composition Formula (A)-1.
[13] The MCC according to [12], in which Composition Formula (A)-1 satisfies 0.01≤x1≤0.44, 0.01≤y≤0.44, 0.01≤x1+y≤0.44, and −0.45≤t≤1.8.
[14] The MCC according to any one of to [13], in which A/B is 0.24 to 0.46.
[15] The MCC according to any one of to [14], in which a low density portion is substantially continuously present in a circumferential direction of the secondary particle X in a cross section of the secondary particle X.
[16] The MCC according to any one of to [15], in which MSD is 6 to 60 Å.
[17] A method for producing an MCC, including: a reaction step of continuously supplying a metal-containing aqueous solution containing Ni and an alkaline aqueous solution to a reaction tank, causing continuous crystal growth, and continuously taking out an MCC, in which in the reaction step, a flow rate of the alkaline aqueous solution is increased or decreased while continuously supplying the alkaline aqueous solution to the reaction tank, the number of fluctuations in the increase or the decrease per hour is 50 to 80, and a rate of change in the flow rate of the alkaline aqueous solution is 7% to 16%.
[18] A method for producing a LiMO, including: a step of mixing the MCC according to any one of to with a lithium compound and calcining an obtained mixture.

### EXAMPLES

Next, the present invention will be described in more detail with reference to examples.

### <Calculation of Initial Efficiency of Lithium Secondary Battery>

The initial efficiency of the lithium secondary battery was calculated by the method described in [Calculation of Initial Efficiency of Lithium Secondary Battery].

### <Method of Measuring Aspect Ratio>

The aspect ratio was measured as described in [Method of Measuring Aspect Ratio] above.

### <Method of Measuring MSD>

The MSD was measured as described in [Method of Measuring MSD] above.

### <Method of Acquiring Binarized Image>

The binarized image was acquired as described in [Method of Acquiring Binarized Image] above.

### <Method of Measuring ASD>

The ASD was measured by [Method of Measuring ASD] described above.

### <Method of Acquiring SEM Image of Cross Section of Secondary Particle>

The SEM image of the cross section of the secondary particle was acquired as described in [Method of Acquiring SEM Image of Cross Section of Secondary Particle] above.

### <Measurement of D₅₀>

D₅₀ of the MCC was measured as described in [Method of Acquiring Cumulative Particle Size Distribution Curve].

### <Composition Analysis of MCC>

The compositional analysis of the MCC was carried out by the method described in [Compositional Analysis of MCC].

### Example 1

First, water was put into a reaction tank equipped with a stirrer and an overflow pipe, a sodium hydroxide aqueous solution was supplied thereto, and a liquid temperature (the temperature of the reaction tank) was maintained at 70° C.

A nickel sulfate aqueous solution, a cobalt sulfate aqueous solution, and a manganese sulfate aqueous solution were mixed to prepare a metal-containing aqueous solution.

Next, the metal-containing aqueous solution and an ammonium sulfate aqueous solution as a complexing agent were each continuously added to the reaction tank under stirring at a ratio such that an atomic ratio of Ni, Co, and Mn in the reaction tank was 83:12:5. In addition, a flow rate of the sodium hydroxide aqueous solution was increased or decreased while continuously supplying the sodium hydroxide aqueous solution to the reaction tank. Specifically, an initial flow rate S1 of the sodium hydroxide aqueous solution was set, the flow rate was increased from the initial flow rate S1 to a flow rate set value S2, and the flow rate was decreased from S2 to a flow rate set value S3.

Next, the flow rate of the sodium hydroxide aqueous solution was increased to S2 again, and then the flow rate was decreased from S2 to S3. Thereafter, an operation of increasing the flow rate of the sodium hydroxide aqueous solution to S2 and then decreasing the flow rate to S3 was repeated.

At this time, the flow rate of the sodium hydroxide aqueous solution was controlled such that the number of fluctuations in the increase or decrease in the flow rate of the sodium hydroxide aqueous solution per hour was 31 and a rate of change in the flow rate of the sodium hydroxide aqueous solution was 6.3%.

As a result, a reaction product was obtained.

After washing the reaction product, the reaction product was dehydrated by a centrifuge, isolated, and dried at 105° C. to obtain an MCC1, which is a nickel cobalt manganese metal composite hydroxide.

The MCC1 contained secondary particles which were aggregates of primary particles.

In Composition Formula (A), the MCC1 had x=0.166, z=0, and t=0.

In Composition Formula (A)-1, the MCC1 had x1=0.119, y=0.047, and t=0.

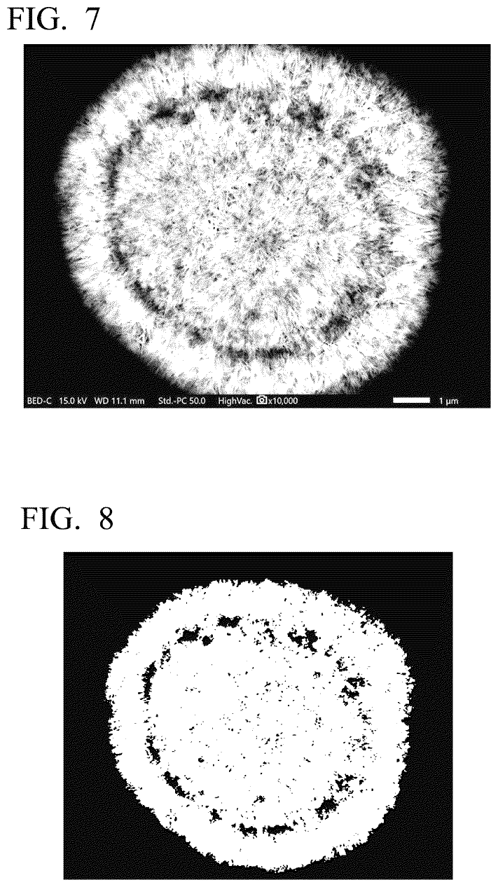

FIG. 7 shows an SEM image of a cross section of one secondary particle included in the MCC1.

FIG. 7 is an SEM image of 1280×960 pixels at a magnification of 10,000 times.

The SEM image of FIG. 7 was imported into Image J to obtain a 256-gradation image, a threshold was set to 90, and a binarized image was obtained. The binarized image obtained in this case is shown in FIG. 8. In FIG. 8, a white portion is a high density portion, and a black portion is a low density portion.

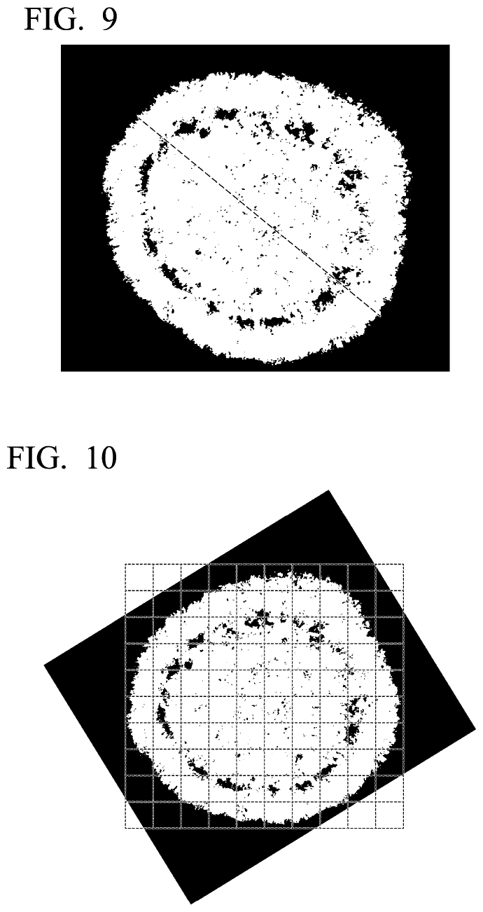

In a case where a diameter (major axis length) of one secondary particle for which the binarized image was acquired was measured, the diameter was 11.4 μm. The major axis length at this time is indicated by a broken line in FIG. 9.

Next, as shown in FIG. 10, a grid was superimposed on the binarized image. One side of the grid was set to 1.14 μm, which is 1/10 of the major axis length of 11.4 μm.

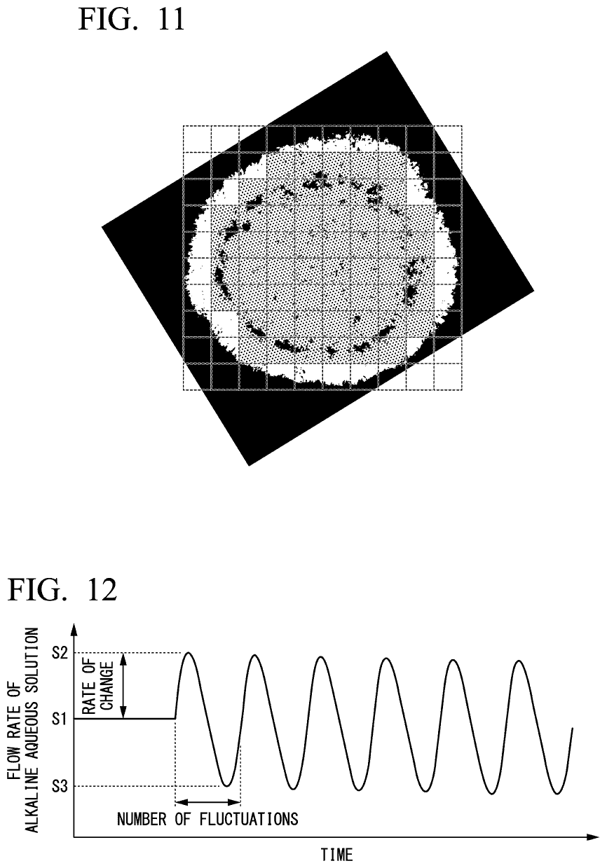

Furthermore, for all of 30 or more overlapping cells among cells where each cell completely overlapped the binarized image, a proportion of a black area in each cell is measured. As shown in FIG. 11, the number of cells that completely overlapped the extracted binarized image was 56. The proportion of the black area in each cell was obtained using the tool of Image J.

As a result of calculating the ASD from a value of the proportion of the black area in each cell in all the obtained cells, the ASD was 8.31%.

It can be confirmed that the secondary particle shown in FIG. 7 was a secondary particle X having a high density portion and a low density portion from the binarized image of FIG. 8, and the MCC1 included the secondary particle X. In addition, in the cross section of the secondary particle X, the low density portion was present substantially continuously in the circumferential direction of the secondary particle as in the form shown in FIG. 3.

For the MCC1, the total number B of secondary particles included in the MCC1 was calculated based on a plurality of visual fields of the SEM image of the cross section of the secondary particle acquired by [Method of Acquiring SEM Image of Cross Section of Secondary Particle] described above, the total number B was 83. In addition, for each of the secondary particles, the ASD and the aspect ratio of the primary particles were calculated by the above-described method. The number A of particles in which the ASD and the aspect ratio of the primary particles were in a range corresponding to the secondary particles X was calculated, and the number A was 28. As a result of calculating A/B from the obtained values, A/B was 0.33.

For the MCC1, the results of the MSD of the secondary particles, the ASD of the secondary particles X, the aspect ratio of the primary particles included in the secondary particles X, A/B and D₅₀ of the MCC1, and the initial efficiency of the lithium secondary battery are shown in Table 1 (the same applies to the following examples and comparative examples).

### Example 2

First, water was put into a reaction tank equipped with a stirrer and an overflow pipe, a sodium hydroxide aqueous solution was supplied thereto, and a liquid temperature was maintained at 70° C.

A nickel sulfate aqueous solution, a cobalt sulfate aqueous solution, and an aluminum sulfate aqueous solution were mixed to prepare a metal-containing aqueous solution.

Next, the metal-containing aqueous solution and an ammonium sulfate aqueous solution as a complexing agent were each continuously added to the reaction tank under stirring at a ratio such that an atomic ratio of Ni, Co, and Al in the reaction tank was 88:9:3. In addition, a flow rate of the sodium hydroxide aqueous solution was increased or decreased while continuously supplying the sodium hydroxide aqueous solution to the reaction tank. The flow rate of the sodium hydroxide aqueous solution was controlled in the same manner as in Example 1, except that the number of fluctuations per hour in the increase or decrease in the flow rate of the sodium hydroxide aqueous solution was set to 50 and a rate of change in the flow rate of the sodium hydroxide aqueous solution was set to 14.4%. As a result, a reaction product was obtained.

After washing the reaction product, the reaction product was dehydrated by a centrifuge, isolated, and dried at 105° C. to obtain an MCC2, which is a nickel cobalt aluminum metal composite hydroxide.

The MCC2 contained secondary particles which were aggregates of primary particles.

In Composition Formula (A), the MCC2 had x=0.095, z=0, and t=0.

In Composition Formula (A)-1, the MCC2 had x1=0.043, y=0.052, and t=0.

The MCC 2 had a high density portion and a low density portion in a binarized image, and in a cross section of the secondary particle, the low density portion was present substantially continuously in a circumferential direction of the secondary particle as in the form shown in FIG. 3.

### Example 3

First, water was put into a reaction tank equipped with a stirrer and an overflow pipe, a sodium hydroxide aqueous solution was supplied thereto, and a liquid temperature was maintained at 70° C.

A nickel sulfate aqueous solution, a manganese sulfate aqueous solution, and an aluminum sulfate aqueous solution were mixed to prepare a metal-containing aqueous solution.

Next, the metal-containing aqueous solution and an ammonium sulfate aqueous solution as a complexing agent were each continuously added to the reaction tank under stirring at a ratio such that an atomic ratio of Ni, Mn, and Al in the reaction tank was 93:3.5:3.5. In addition, a flow rate of the sodium hydroxide aqueous solution was increased or decreased while continuously supplying the sodium hydroxide aqueous solution to the reaction tank. The flow rate of the sodium hydroxide aqueous solution was controlled in the same manner as in Example 1, except that the number of fluctuations per hour in the increase or decrease in the flow rate of the sodium hydroxide aqueous solution was set to 88 and a rate of change in the flow rate of the sodium hydroxide aqueous solution was set to 4.0%. As a result, a reaction product was obtained.

After washing the reaction product, the reaction product was dehydrated by a centrifuge, isolated, and dried at 105° C. to obtain an MCC3, which is a nickel manganese aluminum metal composite hydroxide.

The MCC3 contained secondary particles which were aggregates of primary particles.

In Composition Formula (A), the MCC3 had x=0.073, z=0, and t=0.

In Composition Formula (A)-1, the MCC3 had x1=0.036, y=0.037, and t=0.

The MCC 3 had a high density portion and a low density portion in a binarized image, and in a cross section of the secondary particle, the low density portion was present substantially continuously in a circumferential direction of the secondary particle as in the form shown in FIG. 3.

### Comparative Example 1

An MCC11, which is a nickel cobalt manganese metal composite hydroxide, was obtained by the same method as that in Example 1, except that the number of fluctuations per hour in the increase or decrease in the flow rate of the sodium hydroxide aqueous solution was set to 29 and the rate of change in the flow rate of the sodium hydroxide aqueous solution was set to 1.4%.

The MCC11 contained secondary particles which were aggregates of primary particles.

In Composition Formula (A), the MCC11 had x=0.17, z=0, and t=0.

In Composition Formula (A)-1, the MCC11 had x1=0.121, y=0.049, and t=0.

The MCC 11 did not have a low density portion from a binarized image.

TABLE 1

| | Presence or | Shape of | | | | | | Initial | Initial | |
|---|---|---|---|---|---|---|---|---|---|---|
| | absence of | low | | | | | | charge | discharge | Initial |
| | low density | density | Aspect | MSD | ASD | A/B | D₅₀ | capacity | capacity | efficiency |
| | portion | portion | ratio | Å | % | — | μm | mAh/g | mAh/g | % |
| Example 1 | Present | Concentric | 7.36 | 24.58 | 8.31 | 0.33 | 11.9 | 255.6 | 193.4 | 85.7 |
| | | circle | | | | | | | | |
| Example 2 | Present | Concentric | 7.17 | 0.12 | 6.61 | 0.28 | 12.1 | 239.4 | 208.1 | 87.0 |
| | | circle | | | | | | | | |
| Example 3 | Present | Concentric | 7.20 | 8.16 | 5.64 | 0.21 | 15.3 | 226.0 | 191.0 | 84.5 |
| | | circle | | | | | | | | |
| Comparative | Absent | — | 6.91 | 148.93 | 0.35 | 0 | 11.2 | 233.3 | 183.0 | 78.4 |
| Example 1 | | | | | | | | | | |

As shown in the above results, it was confirmed that a lithium secondary battery having a high initial efficiency is obtained in a case where a CAM using an MCC containing secondary particles X having a high density portion and a low density portion as a raw material is used.

On the other hand, in the comparative example using the MCC, which is a secondary particle having no low density portion, the initial efficiency was lower than that in Example. It is presumed that this is because there is no low density portion through which lithium ions can easily permeate and thus the MCC and the lithium compound are not uniformly calcined during calcination.

### REFERENCE SIGNS LIST

1 Separator
2 Positive electrode
2a Positive electrode active material layer
2b Positive electrode current collector
3 Negative electrode
4 Electrode group
5 Battery can
6 Electrolytic solution
7 Top insulator
8 Sealing body
10 Lithium secondary battery
21 Positive electrode lead
31 Negative electrode lead
100 Laminate
110 Positive electrode
111 Positive electrode active material layer
112 Positive electrode current collector
113 External terminal
120 Negative electrode
121 Negative electrode active material layer
122 Negative electrode current collector
123 External terminal
130 Solid electrolyte layer
200 Exterior body
200a Opening portion
1000 All-solid-state lithium secondary battery

1. A metal composite compound containing at least Ni, the metal composite compound comprising:
primary particles; and
secondary particles which are aggregates of the primary particles,
wherein the primary particles constituting the secondary particles have a standard deviation of a minor diameter of 0.1 Å or more and 100 Å or less,
the secondary particles include secondary particles X having a high density portion in which the primary particles are aggregated at a high density and a low density portion in which the primary particles are aggregated at a low density, and
in a case where a binarized image is obtained by binarizing the high density portion and the low density portion in a scanning electron microscope image of a cross section of the secondary particle X, a standard deviation of a ratio of an area of the low density portion of the secondary particle X, which is obtained from the binarized image, is 0.5% or more and 20% or less, and an aspect ratio of the primary particles constituting the secondary particle X is 7 or more.

2. The metal composite compound according to claim 1,
wherein D₅₀ of the metal composite compound satisfies Expression (1),
$$5 μ m \leq {D}_{50} \leq 20 μ m \qquad ( 1 )$$
(D₅₀ is a particle diameter (μm) at which a cumulative volume from a small particle side is 50% in a case where a total cumulative volume in a cumulative particle size distribution curve obtained by measuring the metal composite compound with a laser diffraction type particle size distribution measuring device is set to 100%).

3. The metal composite compound according to claim 1,
wherein the metal composite compound is represented by Composition Formula (A), 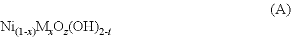
(in Composition Formula (A), 0<x≤0.5, 0≤z≤3, −0.5≤t≤2, and t−z<2 are satisfied, and M is one or more elements selected from the group consisting of Co, Mn, Fe, Cu, Ti, Mg, Al, W, Mo, Nb, Zn, Sn, Zr, Ga, V, B, Si, S, and P).

4. The metal composite compound according to claim 1,
wherein, in a case where the number of the secondary particles X is denoted by A and the total number of secondary particles included in the metal composite compound is denoted by B, A/B is 0.20 or more.

5. The metal composite compound according to claim 1,
wherein the low density portion is substantially continuously present in a circumferential direction of the secondary particle X in the cross section of the secondary particle X.

6. A method for producing a metal composite compound, comprising:
a reaction step of continuously supplying a metal-containing aqueous solution containing Ni and an alkaline aqueous solution to a reaction tank, causing continuous crystal growth, and continuously taking out a metal composite compound,
wherein in the reaction step, a flow rate of the alkaline aqueous solution is increased or decreased while continuously supplying the alkaline aqueous solution to the reaction tank, the number of fluctuations in the increase or the decrease per hour is 30 or more and 100 or less, and a rate of change in the flow rate of the alkaline aqueous solution is 3% or more and 20% or less.

7. A method for producing a lithium metal composite oxide, comprising:
a step of mixing the metal composite compound according to claim 1 with a lithium compound and calcining an obtained mixture.
